(19) United States
(12) Patent Application Publication
(10) Pub. No.: US 2020/0341454 A1
(43) Pub. Date: Oct. 29, 2020

(54) FACTOR ANALYSIS METHOD, FACTOR ANALYSIS DEVICE, AND FACTOR ANALYSIS PROGRAM

(71) Applicant: NEC Corporation, Minato-ku, Tokyo (JP)

(72) Inventor: Takehiko MIZOGUCHI, Tokyo (JP)

(73) Assignee: NEC Corporation, Minato-ku, Tokyo (JP)

(21) Appl. No.: 16/464,315

(22) PCT Filed: Nov. 28, 2016
(86) PCT No.: PCT/JP2016/085214

§ 371 Date: May 28, 2019

(51) Int. Cl. G05B 19/418; G05B 23/02; G06F 17/18; G06Q 50/04

(52) U.S. Cl. CPC G05B 19/418; G06Q 50/04; G06F 17/18; G05B 23/02

(57) ABSTRACT

A factor analysis device includes: a grouping unit 501 to divide a plurality of time-series of explanation that are time-series of data of a plurality of explanatory variables corresponding to a time-series of objective that is time-series of data of one objective variable, into one or more groups such that time-series of explanation having a similarity relationship belong to a same group; a representative time-series extraction unit 502 to extract a representative time-series of explanation from each group; and an analysis unit 503 to analyze an extracted time-series of explanation to identify a time-series of explanation considered to be an influence factor for the time-series of objective.

### TECHNICAL FIELD

The present invention relates to a factor analysis method, a factor analysis device, and a factor analysis program, for identifying an explanatory variable that is considered to be a factor that determines a value change of an objective variable.

### BACKGROUND ART

A technique for analyzing a relationship between an objective variable and an explanatory variable to identify an explanatory variable or its time-series of data that has a strong influence on a value change of the objective variable has been widely used in quality control such as in a manufacturing process.

For example, the above-described technique is used to identify an observation value that has an influence on changes in a value of the objective variable such as product quality, in a situation where various observation values can be obtained every moment from a sensor and the like as a plurality of explanatory variables.

In a case where time-series of data of a plurality of explanatory variables (hereinafter, referred to as a time-series of explanation) is received corresponding to time-series of data of one objective variable (hereinafter, referred to as a time series of objective), a statistical method such as regression analysis can be mentioned as an example of an analysis method for identifying a time-series of explanation considered to be a factor that has a strong influence on the time-series of objective, that is, that determines a value change of the time-series of objective. Many analyses represented by regression analysis are methods of multi-dimensionally analyzing observed data, on the assumption that data observed from a measuring instrument such as a sensor can be used. Hereinafter, the factor that determines a value change of the time-series of objective may be expressed simply as an influence factor.

Regarding such a factor analysis technique, PTL 1 describes a method of segmenting time-series of data of an explanatory variable on the basis of nominal scale data, and then performing a multivariate analysis on data constituted of segments and their dummies, to identify a factor, in a case where the explanatory variable includes the nominal scale data such as a name of a manufacturing device.

Further, PTL 2 describes a method of performing linear multiple regression analysis on all division groups obtained by dividing a plurality of explanatory variables, and analyzing a cause of quality fluctuation of a manufacturing line by repeating an operation for narrowing down the explanatory variables.

Further, NPL 1 describes that a degree of influence of an explanatory variable can be estimated with high accuracy by randomly sampling a sample and repeatedly using a regression approach called LASSO. Further, NPL 2 describes a random forest classifier using a plurality of determination trees as a classifier for factor analysis.

### CITATION LIST

### Patent Literature

PTL 1: Japanese Patent Application Laid-Open No. 2009-258890
PTL 2: Japanese Patent Application Laid-Open No. 2002-110493

### Non Patent Literature

NPL 1: Nicolai Meinshausen, Peter Buhlmann, “Stability selection”, Journal of the Royal Statistical Society: Series B (Statistical Methodology)”, ISSN: 1467-9868, Vol. 72, Issue 4, 2010, pp. 417-473.
NPL 2: Breiman. L, “Random Forests”, Machine Learning, ISSN: 0885-6125, Vol. 45, No. 1, 2001, pp. 5-32.

### SUMMARY OF INVENTION

### Technical Problem

In an actual physical system such as a manufacturing process, measurement values by a plurality of different measurement methods and their correction values are simultaneously collected for one item of a physical quantity to be observed. In this case, there will be many time-series of explanation affecting one time-series of objective indicating a state of the system in the same or similar manner. In such a case, the time-series of explanation has multicollinearity, causing a problem that factor analysis by a general multivariate analysis such as multiple regression analysis is difficult.

Further, even in a case of using an analysis that is not affected by multicollinearity, if there are a large number of second time-series of explanation affecting a value change of the time-series of objective in the same or similar manner to a first time-series of explanation that is strongly involved in the value change of the time-series of objective, all of them are to have a high degree of contribution to the objective variable. As a result, a degree of contribution of a third time-series of explanation that is not similar to the first time-series of explanation, that is, different from the first time-series of explanation, becomes relatively low. At this time, in a case where the third time-series of explanation includes a time-series of explanation considered to be an influence factor, since the first and second time-series of explanation are ranked high in the contribution, there is a problem that it is not possible to correctly extract the third time-series of explanation that is a different kind of factor.

Meanwhile, the method described in PTL 1 is to improve factor identification accuracy by using nominal scale data when the nominal scale data is included in an explanatory variable, but is not to solve the above problem in such a case where there is a large amount of quantitative data affecting a time-series of objective in the similar manner.

Moreover, even when the method described in PTL 2 is applied, in addition to the problem of multicollinearity, there is a similar problem that a third time-series of explanation is excluded by narrowing down the explanatory variables. Also in the methods described in NPL 1 and NPL 2, the problem that the third time-series of explanation cannot be correctly extracted is similar.

In view of the problems described above, an object of the present invention is to provide a factor analysis method, a factor analysis device, and a factor analysis program capable of correctly identifying an influence factor even when there are multiple types of time-series of explanation considered to be an influence factor for one time-series of objective, and there are a plurality of time-series of explanation affecting a time-series of objective in the similar manner among the time-series of explanation considered to be an influence factor.

### Solution to Problem

In a factor analysis method according to the present invention, when a plurality of time-series of explanation, which are time-series of data of a plurality of explanatory variables corresponding to a time-series of objective that is time-series of data of one objective variable, are received, the time-series of explanation are divided into one or more groups such that similar time-series of explanation belong to a same group, a representative time-series of explanation is extracted from each group, the extracted time-series of explanation is analyzed, and a time-series of explanation considered to be an influence factor for the time-series of objective is identified.

A factor analysis device according to the present invention includes: a grouping unit which divides a plurality of time-series of explanation, which are time-series of data of a plurality of explanatory variables corresponding to a time-series of objective that is time-series of data of one objective variable, into one or more groups such that similar time-series of explanation belong to a same group; a representative time-series extraction unit which extracts a representative time-series of explanation from each group; and an analysis unit which analyzes an extracted time-series of explanation to identify a time-series of explanation considered to be an influence factor for the time-series of objective.

A factor analysis program according to the present invention causes a computer to execute: a process of dividing a plurality of time-series of explanation, which are time-series of data of a plurality of explanatory variables corresponding to a time-series of objective that is time-series of data of one objective variable, into one or more groups such that similar time-series of explanation belong to a same group; a process of extracting a representative time-series of explanation from each group; and a process of analyzing an extracted time-series of explanation to identify a time-series of explanation considered to be an influence factor for the time-series of objective.

### Advantageous Effects of Invention

According to the present invention, it is possible to correctly identify an influence factor even when there are multiple types of time-series of explanation considered to be an influence factor for one time-series of objective, and there are a plurality of time-series of explanation affecting a time-series of objective in the similar manner among the time-series of explanation considered to be an influence factor.

### BRIEF DESCRIPTION OF DRAWINGS

FIG. 1 It depicts a block diagram showing an example of a factor analysis device according to a first exemplary embodiment.

FIG. 2 It depicts a flow chart showing an operation example of the factor analysis device of the first exemplary embodiment.

FIG. 3 It depicts a block diagram showing another example of the factor analysis device of the first exemplary embodiment.

FIG. 4 It depicts an explanatory view showing an example of a grouping result.

FIG. 5 It depicts an explanatory view showing an example of a calculation result of a contribution.

FIG. 6 It depicts an explanatory view showing an example of a contribution after integration.

FIG. 7 It depicts an explanatory view showing an example of a factor display method.

FIG. 8 It depicts a schematic block diagram showing a configuration example of a computer according to each exemplary embodiment of the present invention.

FIG. 9 It depicts a block diagram showing an outline of the present invention.

FIG. 10 It depicts a flowchart showing an example of a factor analysis method of the present invention.

FIG. 11 It depicts a block diagram showing another example of the factor analysis device of the present invention.

FIG. 12 It depicts a flowchart showing another example of the factor analysis method of the present invention.

### DESCRIPTION OF EMBODIMENTS

An exemplary embodiment of the present invention is described below with reference to drawings.

### First Exemplary Embodiment

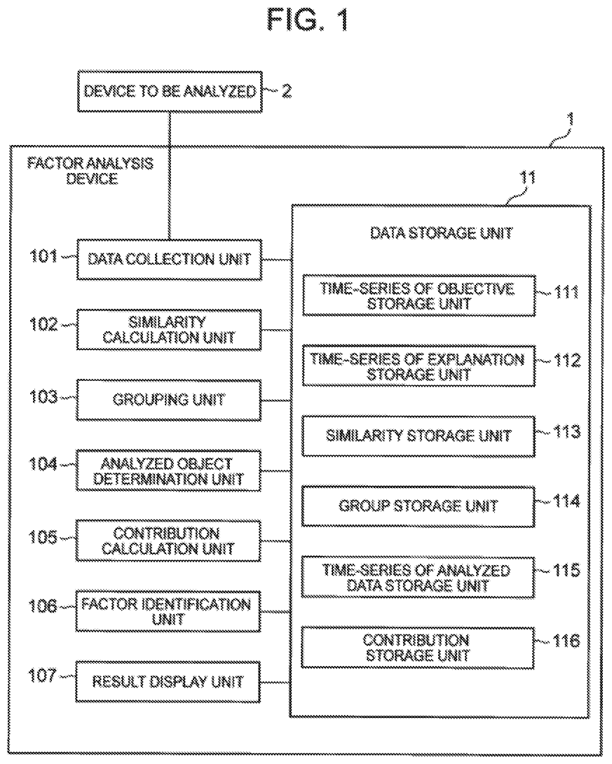

FIG. 1 is a block diagram showing an example of a factor analysis device according to a first exemplary embodiment. In the present exemplary embodiment, as an example, a case where a factor analysis device 1 is applied for quality control of manufactured products in a manufacturing process will be described. Meanwhile, the factor analysis device 1 may be applied for a process other than a manufacturing process or for applications other than quality control in a manufacturing process.

As shown in FIG. 1, the factor analysis device 1 of the present exemplary embodiment is connected to a device 2 to be analyzed. Note that, although not shown, a plurality of devices 2 to be analyzed may be provided. The device 2 to be analyzed is, for example, a device used in a manufacturing process. As described above, the factor analysis device 1 of the present exemplary embodiment is used in the manufacturing process in which the device 2 to be analyzed is used.

In this example, the device 2 to be analyzed measures a plurality of types of observation values regarding the device 2 to be analyzed itself at predetermined time intervals, and transmits to the factor analysis device 1. Items of the observation value include one or more items related to a state of manufactured products, such as a quality index, and one or more items related to a manufacturing condition. Examples of the item related to a manufacturing condition include a temperature, a pressure, a gas flow rate, and the like. An observation value of the item related to a manufacturing condition is represented by a numerical value, such as an integer and a decimal, for example. Further, an observation value of the item related to the quality index may be represented by a symbol such as “normal”/“abnormal” or “open”/“closed”, for example.

An object of the present exemplary embodiment is to identify an item of a manufacturing condition considered to be a factor (influence factor) that determines a state of the manufactured product, or identify time-series of data of observation values of the item, with the observation value of the item related to a manufacturing condition of the manufactured product as an explanatory variable, and the observation value of the item related to a state of the manufactured product as an objective variable. Note that the explanatory variable and the objective variable are not limited to this. For example, if quality control on system operation is desired to be performed, it is possible to use an observation value of an item related to an operating condition such as system operation information as the explanatory variable, and use an observation value of an item related to a performance index corresponding to the operation information such as an operation state of the system as the objective variable. In general, the present invention is applicable to any process or application as long as a plurality of explanatory variables and an objective variable described by the plurality of explanatory variables can be obtained in association with each other.

In the present exemplary embodiment, “time-series of data” refers to a data group (series data) in which values related to one item observed by a sensor or the like are arranged in time order at predetermined time intervals. Further, “time-series of explanation” refers to time-series of data obtained by arranging observation values representing manufacturing conditions among received observation values in time order for each observation object. Meanwhile, the time-series of explanation may be, for example, time-series of data obtained by arranging observed values in time order for each device 2 to be analyzed and each item related to a manufacturing condition. The time-series of explanation widely includes a manufacturing condition indicating an operating state of the device, such as an adjustment value of the device, a temperature, a pressure, gas flow rate, and a voltage. Here, each observation object includes not only distinction of physical items, but also distinction of devices that perform observation and distinction of measurement methods. That is, in the present exemplary embodiment, observation objects with acquisition circuits completely coincident with each other are regarded as a same observation object, while others regarded as different observation objects, and a variable name (time-series of data identifier) is assigned to each observation object. This means that, for example, observation objects are different in a pressure observed by a first device 2 to be analyzed and a pressure observed by a second device 2 to be analyzed. Similarly, for example, this means that observation objects are different in a pressure observed by the first device 2 to be analyzed and a corrected pressure obtained by correcting the pressure. Thus, in the present exemplary embodiment, the explanatory variables are preferably subdivided.

Further, “time-series of objective” refers to time-series of data obtained by arranging, in time order, observation values representing a state of a manufactured product among received observation values. The time-series of objective may be, for example, time-series of data obtained by arranging, in time order, observation values representing a quality index, which are measured for each device 2 to be analyzed. In this case, while the time-series of objective for several minutes of the device 2 to be analyzed are obtained, these are regarded as the time-series of objective corresponding to an item of a same kind, which is a quality index. Hereinafter, in the present exemplary embodiment, a case is assumed where the time-series of objective as an analyzed object is one type, but the time-series of objective may widely include an evaluation index such as a manufactured product obtained when the device is operated under the manufacturing conditions represented by the time-series of explanation, such as quality, yield, and efficiency.

The factor analysis device 1 shown in FIG. 1 includes a data collection unit 101, a similarity calculation unit 102, a grouping unit 103, an analyzed object determination unit 104, a contribution calculation unit 105, a factor identification unit 106, a result display unit 107, and a data storage unit 11. In addition, the data storage unit 11 includes a time-series of objective storage unit 111, a time-series of explanation storage unit 112, a similarity storage unit 113, a group storage unit 114, a time-series of analyzed data storage unit 115, and a contribution storage unit 116.

The data collection unit 101 obtains an observation value from the device 2 to be analyzed. In addition, the data collection unit 101 causes the time-series of objective storage unit 111 or the time-series of explanation storage unit 112 to store the obtained observation values in according with the item.

The time-series of objective storage unit 111 stores, as a time-series of objective, an observation value related to a quality index among the observation values obtained by the data collection unit 101. The time-series of objective storage unit 111 may store, for example, the obtained observation value in association with an item corresponding to the observation object and as data arranged in time series.

The time-series of explanation storage unit 112 stores, as a time-series of explanation, an observation value related to a manufacturing condition among the observation values obtained by the data collection unit 101. The time-series of explanation storage unit 112 may store, for example, the obtained observation value in association with an item corresponding to the observation object and as data arranged in time series.

The similarity calculation unit 102 calculates a similarity between time-series of data for all pairs, which are all combinations of the time-series of explanation, for all the time-series of explanation stored in the time-series of explanation storage unit 112.

Here, the “similarity” between time-series of data is an index indicating a degree of similarity between two pieces of time-series of data, and a larger similarity means that the two pieces of time-series of data are more “similar”. The similarity calculation unit 102 may use, for example, a correlation coefficient that can be calculated between two pieces of time-series of data, as the similarity.

The similarity storage unit 113 stores the similarity calculated by the similarity calculation unit 102.

The grouping unit 103 reads out the similarity for all pairs of the time-series of explanation from the time-series of explanation storage unit 112, and executes grouping for dividing the time-series of explanation into one or more groups on the basis of the read similarity. In the present exemplary embodiment, a “group” of time-series of data is a set of one or more pieces of similar time-series of data. If there is only one piece of time-series of data belonging to a same group, it means that “there is no other time-series of data similar to itself”.

The group storage unit 114 stores information of the group classified by the grouping unit 103. The group storage unit 114 may store, for example, an identifier of the group assigned to the time-series of explanation in association with an identifier of each time-series of explanation. Further, the group storage unit 114 may store, for example, an identifier or a number (number of elements) and the like of the time-series of explanation belonging to the group in association with the identifier of each group.

The analyzed object determination unit 104 refers to the information of the group stored in the group storage unit 114, and determines a time-series of explanation to be an analyzed object (object for calculation of contribution) of the contribution calculation unit 105 in the latter stage. Hereinafter, the time-series of explanation determined as the analyzed object by the analyzed object determination unit 104 may be expressed as a time series of analyzed data.

The analyzed object determination unit 104 may extract, for example, a representative time-series of explanation from each group and set as a time series of analyzed data. Further, the analyzed object determination unit 104 may set, for example, only the time-series of explanation belonging to a predetermined group as the time series of analyzed data. Note that a more specific method of determining the time series of analyzed data will be described later.

The time-series of analyzed data storage unit 115 stores the time-series of explanation determined as the time series of analyzed data or information thereof by the analyzed object determination unit 104.

The contribution calculation unit 105 reads out the time-series of objective from the time-series of objective storage unit 111, and reads out the time series of analyzed data from the time-series of analyzed data storage unit 115. Further, the contribution calculation unit 105 calculates a contribution to a value change of the time-series of objective, for each of the read time series of analyzed data, by using one or more multivariate analyses. Note that a more specific calculation method of the contribution will be described later.

Meanwhile, instead of the contribution calculation unit 105 reading out the time-series of objective and the time series of analyzed data, the analyzed object determination unit 104 may read out the time series of analyzed data and the time-series of objective, and output to the contribution calculation unit 105.

The contribution storage unit 116 stores the contribution calculated by the contribution calculation unit 105.

On the basis of the contribution stored in the contribution storage unit 116, the factor identification unit 106 identifies a time series of analyzed data that is considered to be an influence factor or a candidate thereof, for the time-series of objective. The factor identification unit 106 may read out the contribution from the contribution storage unit 116 in descending order, for example, and identify, as an influence factor or a candidate thereof, a time series of analyzed data whose contribution is equal to or more than a predetermined value or n pieces of time series of analyzed data that are ranked high in the contribution. Further, for example, when contributions by a plurality of analyses are stored for each of the time series of analyzed data, the factor identification unit 106 may integrate them, and identify an influence factor or a candidate thereof on the basis of the integrated contribution.

The result display unit 107 displays the time series of analyzed data that is considered to be an influence factor or a candidate thereof identified by the factor identification unit 106. At this time, in a case where the result display unit 107 reads out a group to which the identified time series of analyzed data belongs from the group storage unit 114, and the group includes a time-series of explanation other than the time series of analyzed data, the result display unit 107 may also display the time-series of explanation as an influence factor or a candidate thereof.

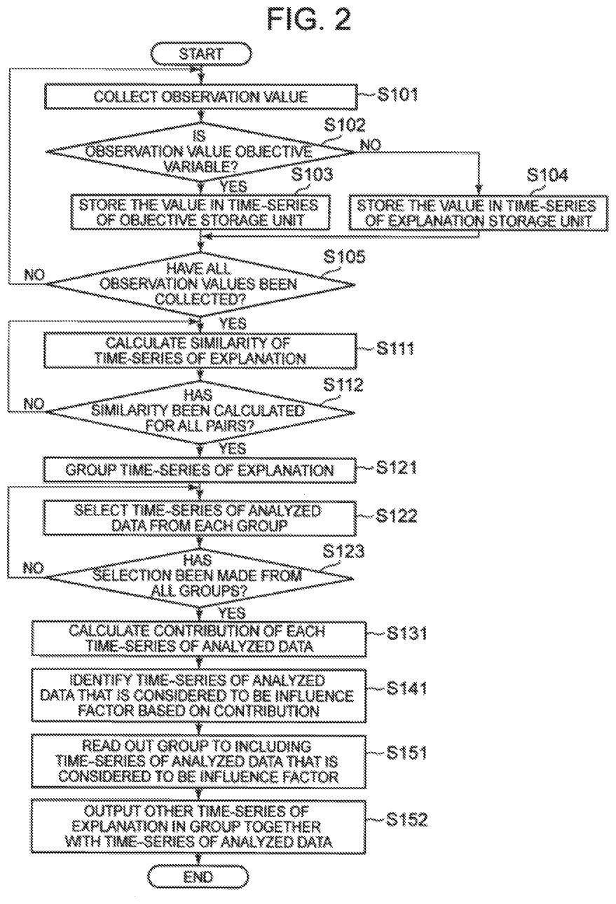

Next, an operation of the factor analysis device 1 of the present exemplary embodiment will be described. FIG. 2 is a flow chart showing an operation example of the factor analysis device 1.

In the example shown in FIG. 2, first, the data collection unit 101 collects an observation value from the device 2 to be analyzed (step S101). Next, the data collection unit 101 checks whether the collected observation value is an explanatory variable, that is, an observation value related to a manufacturing condition, or an objective variable, that is, an observation value related to a quality index (step S102).

In step S102, when the collected observation value is an objective variable (Yes in step S102), the data collection unit 101 stores the observation value in the time-series of objective storage unit 111 (step S103). Whereas, when the collected observation value is not an objective variable (No in step S102), the data collection unit 101 stores the observation value in the time-series of explanation storage unit 112 (step S104).

Next, the data collection unit 101 checks whether or not all the observation values as a collection object have been collected from the device 2 to be analyzed (step S105). If there is an observation value that has not been collected yet (No in step S105), the data collection unit 101 repeats the process from step S101. Whereas, when all the observation values have been collected (Yes in step S105), the data collection unit 101 proceeds with the process to step S111.

In step S111, the similarity calculation unit 102 reads out pairs of time-series of explanation one by one from the time-series of explanation stored in the time-series of explanation storage unit 112, to calculate a similarity. The similarity calculated here is stored in the similarity storage unit 113 together with information of the pair.

Further, the similarity calculation unit 102 checks whether or not the similarity has been calculated for all the pairs in the time-series of explanation (step S112). If there is a pair for which the similarity has not been calculated yet (No in step S112), the similarity calculation unit 102 repeats the process of step S111. Whereas, when the similarity has been calculated for all the pairs (Yes in step S112), the similarity calculation unit 102 proceeds with the process to step S121.

In step S121, the grouping unit 103 performs grouping of the time-series of explanation on the basis of the similarity calculated in step S111. Information of the group generated here is stored in the group storage unit 114.

Next, the analyzed object determination unit 104 selects one time-series of explanation to be an analyzed object (time series of analyzed data) by selecting groups one by one from the groups generated in step S121 (step S122). Information of the time series of analyzed data selected here is stored in the time-series of analyzed data storage unit 115.

Further, the analyzed object determination unit 104 checks whether or not the time series of analyzed data has been selected from all the groups (step S123). If there is a group for which the time series of analyzed data has not been selected (No in step S123), the analyzed object determination unit 104 repeats the process of step S122. Whereas, when the time series of analyzed data has been selected from all the groups (Yes in step S123), the analyzed object determination unit 104 proceeds with the process to step S131.

In step S131, the contribution calculation unit 105 uses one or more multivariate analyses for each of the time series of analyzed data that are the time-series of explanation selected in step S122, to calculate a contribution to a value change of the time-series of objective. The contribution calculated here is stored in the contribution storage unit 116 in association with the used multivariate analysis.

Next, on the basis of the contribution stored in the contribution storage unit 116, the factor identification unit 106 identifies a time series of analyzed data that is considered to be an influence factor (or a candidate thereof) (step S141). For example, when the contributions are calculated using a plurality of multivariate analyses, the factor identification unit 106 may calculate the final contribution by integrating calculated contributions and the like. Then, on the basis of the calculated final contribution, the time series of analyzed data that is considered to be an influence factor or a candidate thereof is identified. In step S141, the factor identification unit 106 may determine, as a factor, for example, a time series of analyzed data with the calculated final contribution ranked high.

Next, the result display unit 107 reads out information of a group to which the time series of analyzed data determined to be an influence factor (or a candidate thereof) belongs (step S151). Finally, the result display unit 107 outputs the time series of analyzed data identified in step S141 as an influence factor, and displays a time-series of explanation other than the time series of analyzed data belonging to the group read out at step S151, together with the time series of analyzed data (step S152).

By the above, the factor analysis device 1 of this example ends a series of factor analysis processing for one time-series of objective.

As described above, when a plurality of time-series of explanation and a time-series of objective corresponding thereto are received, the factor analysis device 1 of the present exemplary embodiment can correctly identify multiple types of factors. In particular, even in a case where there are multiple types of time-series of explanation considered to be an influence factor, and there are many time-series of explanation similar to them, different types of influence factors can be correctly identified. The reason is that the grouping unit 103 groups the time-series of explanation on the basis of the similarity, and selects the time-series of explanation as an analyzed object from the grouped time-series of explanation, by the analyzed object determination unit 104. Consequently, this is because other similar time-series of explanation can be excluded from the analyzed object, and an influence factor can be identified by using time series that are not similar to each other.

Meanwhile, it is assumed that the objective time series as the analyzed object is one or one type in the above description, but the time-series of objective as the analyzed object may be two or more or two or more types. In that case, the factor analysis device 1 may simply perform the process in and after step S122 or in and after step S131 for each or each type of time-series of objective. For example, the factor analysis device 1 may select an analysis time series for each or each type of time-series of objective, then calculate the contribution of the time series of analyzed data, and identify the time series of analyzed data that is considered to be an influence factor on the basis of the calculated contribution. As described above, by performing the above-described process individually for each time-series of objective, it is possible to identify a time-series of explanation considered to be an influence factor for each time-series of objective.

Further, in the above description, an example is shown in which the similarity calculation unit 102 uses, as the similarity, a correlation coefficient that can be calculated between two pieces of time-series of data, but any index may be used as the similarity as long as the index indicates a degree of similarity between two pieces of time-series of data. For example, the similarity calculation unit 102 may use, as the similarity, a degree of fitness of a relational expression established between two pieces of time-series of data. More specifically, the similarity calculation unit 102 may consider the relationship between two pieces of time-series of data as an input-output relationship, and use the degree of fitness when the input-output relationship is function-approximated by regression analysis.

Further, the grouping unit 103 may use any method as a method of grouping the time-series of explanation, as long as the method is based on the similarity of time-series of data. Further, at this time, the time-series of data (time-series of explanation) constituting the group to be generated may simply be one or more. The grouping unit 103 may perform grouping, for example, such that time-series of explanation whose similarity is equal to or more than a certain degree are in a same group in the time-series of explanation. Further, the grouping unit 103 may group the time-series of explanation, for example, by using clustering based on the similarity, such as spectral clustering.

Further, a selection method of the time series of analyzed data may be random or selection by a mathematical method. In a case of using the mathematical method, the analyzed object determination unit 104 may perform selection, for example, on the basis of a mutual information amount with the time series of objective. Furthermore, the analyzed object determination unit 104 may select one or more time-series of explanation from one group, as a time series of analyzed data. In that case, it is preferable to calculate the contribution by a method that can avoid multicollinearity. Note that the analyzed object determination unit 104 may determine the number of time series of analyzed data on the basis of variation in the similarity between the time-series of explanation in the group.

Further, the analyzed object determination unit 104 can also select time-series of data (new time-series of data) derived from the time-series of explanation belonging to a same group, as the time series of analyzed data of the group. The analyzed object determination unit 104 may derive, for example, time-series of data constituted of the sum of individual values of the time-series of explanation belonging to a same group, and use the derived time-series of data as the time series of analyzed data of the group.

Further, the contribution calculation unit 105 may use any analysis as one of the multivariate analyses, as long as the analysis is for calculating the contribution of the explanatory variable to a value change of the objective variable. The contribution calculation unit 105 may use, for example, L1 regularized logistic regression as one of the multivariate analyses. Furthermore, the contribution calculation unit 105 may perform preprocessing such as moving average or frequency analysis on the time series of analyzed data, before applying the multivariate analysis. In that case, the contribution calculation unit 105 performs processing (addition, deletion, change, and the like of data) on the time series of analyzed data on the basis of the data obtained by the preprocessing, and then calculates the contribution.

Further, when the objective variable is an index indicated by a symbol rather than a numerical value, the contribution calculation unit 105 may use a numerical value corresponding to the symbol as a value corresponding to each time of the objective variable. That is, the contribution calculation unit 105 may calculate the contribution after changing the symbol indicated by the objective variable into a numerical value. For example, in a case where the objective variable is indicated by the symbols “normal” and “abnormal”, the L1 regularized logistic regression described in NPL 1 or the random forest described in NPL 2 can be used as the multivariate analyses, by replacing “normal” with 0 and abnormal with 1. Note that the same applies to the explanatory variable.

Further, in the present exemplary embodiment, a plurality of sensors in a manufacturing process, in which a plurality of sensors to observe manufacturing conditions of manufactured products such as a temperature and a gas flow rate are used, are shown as an example of the device 2 to be analyzed. However, the device 2 to be analyzed may be another system as long as the system can obtain a value of the objective variable and a value of the corresponding explanatory variable. For example, the device 2 to be analyzed may be an IT system, a plant system, a structure, or transport equipment. In a case of an IT system, operation information such as CPU usage, memory usage, or disk access frequency or usage is used as the explanatory variable. In addition, a performance index such as power consumption, the number of calculations, or calculation time is used as the objective variable.

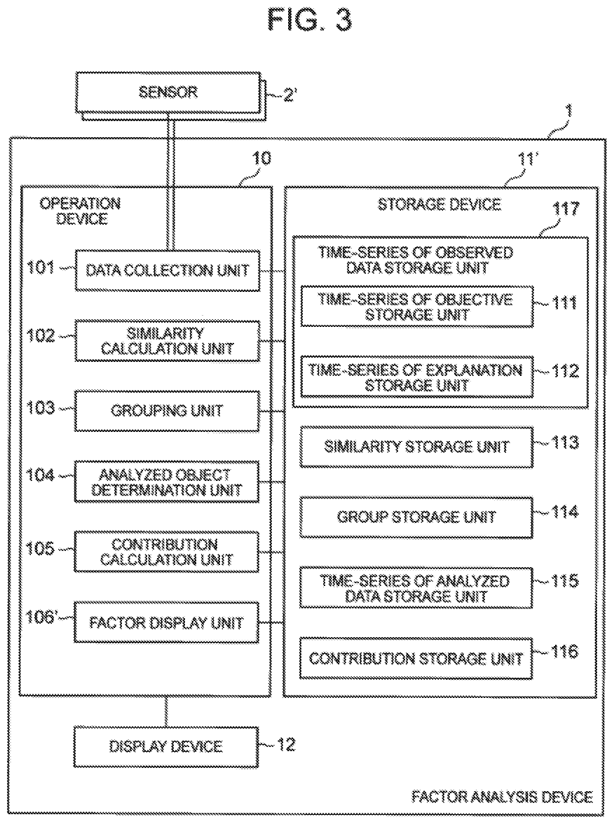

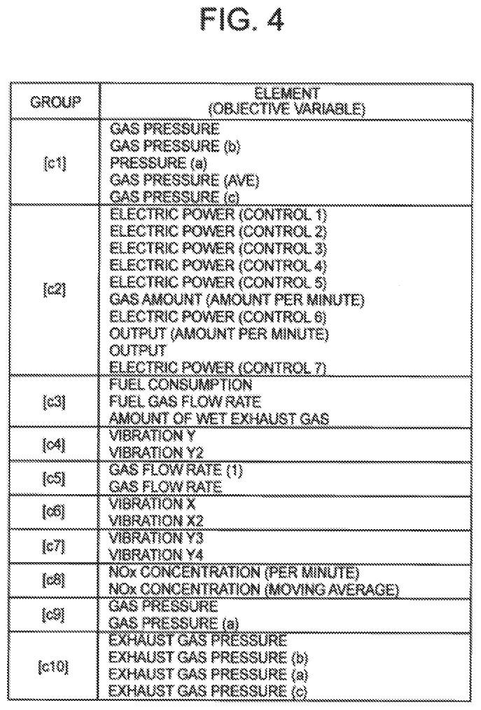

Next, an example of a more specific configuration and operation of the factor analysis device 1 of the present exemplary embodiment will be described with reference to FIGS. 3 to 7. Note that the contents shown in FIGS. 4 to 7 are numerical calculation results based on items actually performed.

A configuration of the factor analysis device 1 in this example is shown in FIG. 3. As shown in FIG. 3, the factor analysis device 1 in this example is connected to two or more sensors 2′.

Further, as shown in FIG. 3, the factor analysis device 1 includes an operation device 10, a storage device 11′, and a display device 12. The operation device 10 includes a data collection unit 101, a similarity calculation unit 102, a grouping unit 103, an analyzed object determination unit 104, a contribution calculation unit 105, and a factor display unit 106′. Note that, in this example, while one factor display unit 106′ is included instead of the factor identification unit 106 and the result display unit 107 described above, the factor display unit 106′ has both functions of these two.

Further, the storage device 11′ further includes a time-series of observed data storage unit 117, a similarity storage unit 113, a group storage unit 114, a time-series of analyzed data storage unit 115, and a contribution storage unit 116. In addition, the time-series of observed data storage unit 117 includes a time-series of objective storage unit 111 and a time-series of explanation storage unit 112.

Next, a specific description is given to a calculation method of a similarity between time-series of explanation, a grouping method for a time-series of explanation, a selection method of a time series of analyzed data, a calculation method of a contribution, an identification method of an influence factor, and a display method of an influence factor, in this example.

First, the calculation method of a similarity between the time-series of explanation will be described. When a correlation coefficient is used as the similarity, the correlation coefficient as the similarity can be calculated as follows. Regarding a value at each time of two pieces of time-series of data X₁ and X₂ as one sample, it is possible to calculate the respective standard deviations σX₁ and σX₂ and the covariance σX₁X₂ of the time-series of data X₁ and X₂. At this time, a correlation coefficient R between the time-series of data X₁ and X₂ can be calculated as R=σX₁X₂/(σX₁·σX₂).

Moreover, in a case of using a degree of fitness of an input-output relationship of two pieces of time-series of data as the similarity, a degree of fitness as the similarity can be calculated as follows. First, assuming an input-output relationship model with one of two pieces of time-series of data X₁ and X₂ as an input and the other as an output, the similarity calculation unit 102 performs function approximation by regression analysis. For example, when X₁ is an input and X₂ is an output, the similarity calculation unit 102 learns a prediction value X₂′ of X₂ by regression analysis as X₂′=f (X₁). Next, the similarity calculation unit 102 calculates a degree of fitness C of the learning result as C=1−(E (X₂−X₂′)/E (X₂−E (X₂))). Here, E ( ) represents an average in ( ).

Meanwhile, the correlation coefficient R or the degree of fitness C described above may be used as the similarity as it is, or a value based on the correlation coefficient or the degree of fitness, such as a weighted average of these, may be used as the similarity.

Next, the grouping method of the time-series of explanation will be described. In this example, time-series of data having a similarity equal to or more than a predetermined value are defined as “similar time-series”. The grouping unit 103 performs grouping by regarding a set of such similar time-series of data as time-series of data belonging to a same group. At this time, if there is no other similar time-series of data, only one time-series of data included in the group.

FIG. 4 is an explanatory view showing an example of a grouping result. Note that FIG. 4 shows a part of the grouping result in a case of using the degree of fitness C of the input-output relationship of two time-series of explanation as the similarity. As can be seen from FIG. 4, time-series of data in a same group is time-series of data constituted of observation values of a same or similar physical quantities. In this way, even when it is not clear what kind of observation values specifically the observation values constituting the time-series of data are, a plurality of time-series of explanation can be classified into one or more types in accordance with action of the time-series of data.

Next, the selection method a time series of analyzed data will be described.

Hereinafter, an example in which a mathematical method is used as the selection method of a time series of analyzed data is described. The analyzed object determination unit 104 of this example selects a time series of analyzed data on the basis of a mutual information amount that can be calculated between the time-series of objective and the time-series of explanation. Assuming that the time-series of objective is Y and the time-series of explanation is X, a mutual information amount I (X, Y) can be calculated as I (X, Y)=H (X)+H (Y)−H (X, Y). Here, H (X) and H (Y) each represent entropy of X and Y. Further, H (X, Y) represents combined entropy of X and Y. The analyzed object determination unit 104 calculates, for a predetermined group (for example, a group having two or more elements), the mutual information amount I with the objective time series for all the time-series of explanation belonging to the group. Then, the analyzed object determination unit 104 selects a time-series of explanation having the largest mutual information amount I as the time series of analyzed data of the group. Note that, for a group whose number of elements is one, the analyzed object determination unit 104 may simply use the time-series of explanation that is the only element, as the time series of analyzed data.

Next, the calculation method of the contribution will be described. The contribution calculation unit 105 of this example uses the time-series of objective as an output, and the time series of analyzed data corresponding to the output as an input, to calculate a contribution by applying a known multivariate analysis. As a result, it is possible to calculate, as the contribution, an influence degree of a non-obvious time series as an input, to a value change of an obvious time series as an output, from the input-output relationship of the two pieces of time-series of data.

More specifically, the contribution calculation unit 105 of this example uses three types of multivariate analyses, such as multiple L1 regularized logistic regression (approach 1), random forest (approach 2), and ReliefF (approach 3) to calculate three types of contribution to a value change of the time-series of objective for one time series of analyzed data. At this time, each contribution is normalized such that the maximum value is 1 and the minimum value is 0.

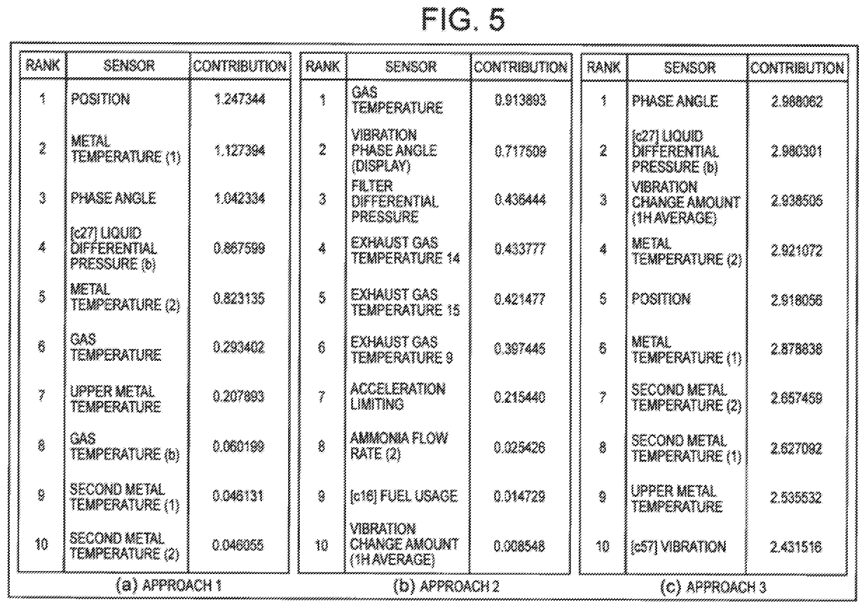

FIG. 5 is an explanatory view showing a calculation result of the contribution of the time series of analyzed data of this example. FIG. 5 shows the top ten for each method among the contributions of individual time series of analyzed data that have been calculated using the above three types of multivariate analyses. Note that (a) of FIG. 5 shows a calculation result of the contribution by approach 1, (b) of FIG. 5 shows a calculation result of the contribution by approach 2, and (c) of FIG. 5 shows a calculation result of the contribution by approach 3.

In (a) to (c) of FIG. 5, “[ ]” attached to the beginning of the sensor name represents an identifier of a group to which the sensor belongs (more specifically, a time-series of explanation constituted of observation values by the sensor). For example, in approach 1 (L1 regularized logistic regression) shown in (a) of FIG. 5, “[c27]” attached to the beginning of a name of the sensor: “liquid differential pressure (b)” with the fourth largest degree of contribution represents that the group to which the corresponding time-series of explanation to which the sensor corresponds belongs is “c27”. Moreover, in a case where the notation of the identifier of a group is omitted, this represents that the group to which the time-series of explanation to which the sensor corresponds belongs is constituted only of the time-series of explanation.

Next, the identification method of an influence factor will be described. The factor display unit 106′ of this example first integrates the contributions calculated using a plurality of multivariate analyses for each time series of analyzed data. Specifically, the factor display unit 106′ takes the sum of the three contributions calculated using the above three types of multivariate analyses for each time series of analyzed data. The method of taking the sum may be a simple sum, or may be a method of taking the sum after weighting for each method.

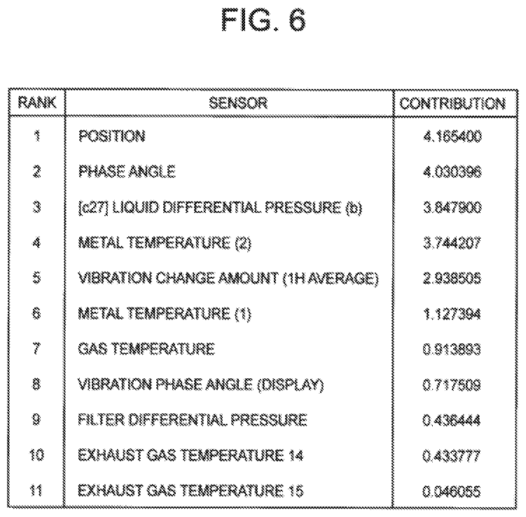

FIG. 6 is an explanatory view showing a contribution after integration of this example. FIG. 6 shows the top 11 contributions after integration together with sensor names and ranks. The factor display unit 106′ may identify, for example, n pieces of time series of analyzed data in descending order of the contribution after integration as the time-series of explanation considered to be an influence factor or one type thereof. Here, one type of the time-series of explanation considered to be an influence factor means that there is another time-series of explanation of the same kind, that is, a time-series of explanation acting in the same or similar manner. In this case, not only the n pieces of time series of analyzed data ranked high in the contribution but also a time-series of explanation acting in the similar manner to them is also considered to be an influence factor or a candidate thereof. According to FIG. 6, for example, a name of the sensor: “liquid differential pressure (b)” with the third largest degree of contribution has a group identifier attached to the beginning of the sensor name. This shows that there is another sensor in the group (more specifically, a time-series of explanation constituted of observation values of the another sensor). In this case, the another sensor is also considered as an influence factor or a candidate thereof.

Next, the display method of an influence factor will be described. The factor display unit 106′ of this example first reads out, from the group storage unit 114, information of a group to which a time series of analyzed data identified to be an influence factor belongs. Then, the factor display unit 106′ displays the time series of analyzed data identified to be an influence factor on the display device 12, and displays, along with the time series of analyzed data, another time-series of explanation in the group to which the time series of analyzed data belongs. Note that the factor display unit 106′ may display information of the time series of analyzed data and information of the group to which the time series of analyzed data belongs, together with the contribution in a descending order of the contribution finally calculated, without limiting the number of the time series of analyzed data to be displayed as an influence factor.

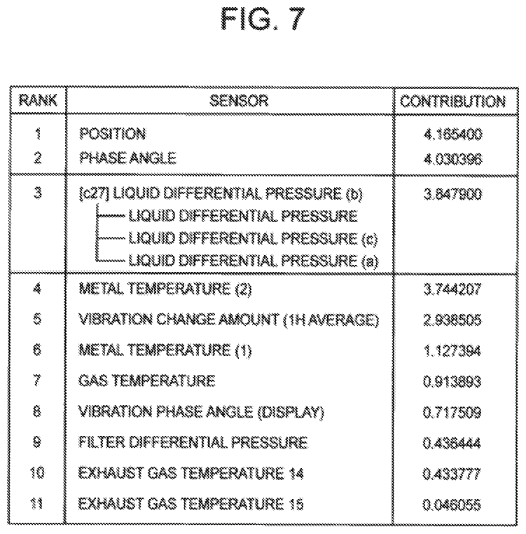

FIG. 7 is an explanatory view showing an example of the display method of an influence factor. In the example shown in FIG. 7, in addition to “liquid differential pressure (b)”, which is one sensor name of the time series of analyzed data that is considered to be an influence factor, sensor names of other time-series of explanation of the group to which the time series of analyzed data belongs are also displayed in a tree form. Thus, in this example, as the information of the time-series of explanation considered to be an influence factor, together with the information of the time series of analyzed data that is ranked high in the contribution, information of the time-series of explanation similar to the time series of analyzed data is displayed in a form of accompanying this. Note that, in practice, the time-series of explanation similar to the time series of analyzed data being displayed does not affect the contribution of the time-series of explanation of other types (other groups), or does not reduce the contribution of other types of time-series of explanation.

From the above results, it can be seen that the factor analysis device 1 has been able to correctly identify an influence factor even in case where there are multiple types of time-series of explanation considered to be an influence factor, and there are many time-series of explanation acting in the similar manner to them.

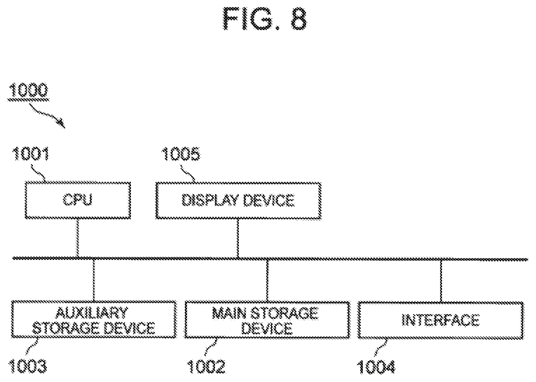

Next, a configuration example of a computer according to each exemplary embodiment of the present invention will be shown. FIG. 8 is a schematic block diagram showing a configuration example of the computer according to each exemplary embodiment of the present invention. A computer 1000 includes a CPU 1001, a main storage device 1002, an auxiliary storage device 1003, an interface 1004, and a display device 1005.

For example, individual processing units (the data collection unit 101, the similarity calculation unit 102, the grouping unit 103, the analyzed object determination unit 104, the contribution calculation unit 105, the factor identification unit 106, and the result display unit 107) in the monitoring system described above may be implemented in the computer 1000 operating as the factor analysis device 1. In that case, operations of these individual processing units may be stored in the auxiliary storage device 1003 in a form of a program. The CPU 1001 reads out the program from the auxiliary storage device 1003 to develop in the main storage device 1002, and performs predetermined processing in each exemplary embodiment in accordance with the program.

The auxiliary storage device 1003 is an example of the non-transitory tangible medium. Other examples of the non-transitory tangible medium include a magnetic disk, a magneto-optical disk, a CD-ROM, a DVD-ROM, a semiconductor memory, and the like, connected via the interface 1004. Further, when this program is distributed to the computer 1000 by a communication line, the computer 1000 that has received the distribution may develop the program in the main storage device 1002 and execute predetermined processing in each exemplary embodiment.

Further, the program may be for realizing a part of predetermined processing in each exemplary embodiment. Furthermore, the program may be a differential program that realizes predetermined processing in each exemplary embodiment in combination with another program already stored in the auxiliary storage device 1003.

Moreover, depending on the processing content in the exemplary embodiment, some elements of the computer 1000 can be omitted. For example, in a case of outputting a specific result to another server or the like connected via a network, the display device 1005 can be omitted. Further, although not shown in FIG. 8, the computer 1000 may have a receiving device depending on the processing content in the exemplary embodiment. For example, in a case where the factor analysis device 1 receives an instruction input for starting analysis, an instruction input for an analysis from a user, or the like, a receiving device for the input of the instruction may be provided.

In addition, part or all of each constituent element of each device is implemented by a general-purpose or dedicated circuit (Circuitry), a processor, or the like, or a combination thereof. These may be configured by a single chip or may be configured by a plurality of chips connected via a bus. In addition, part or all of each constituent element of each device may be realized by a combination of the above-described circuit and the like and a program.

When part or all of each constituent element of each device is realized by a plurality of information processing apparatuses, circuits, and the like, the plurality of information processing apparatuses, circuits, and the like may be arranged concentratedly or distributedly. For example, the information processing apparatus, the circuit, and the like may be realized as a form in which each is connected via a communication network, such as a client and server system, a cloud computing system, and the like.

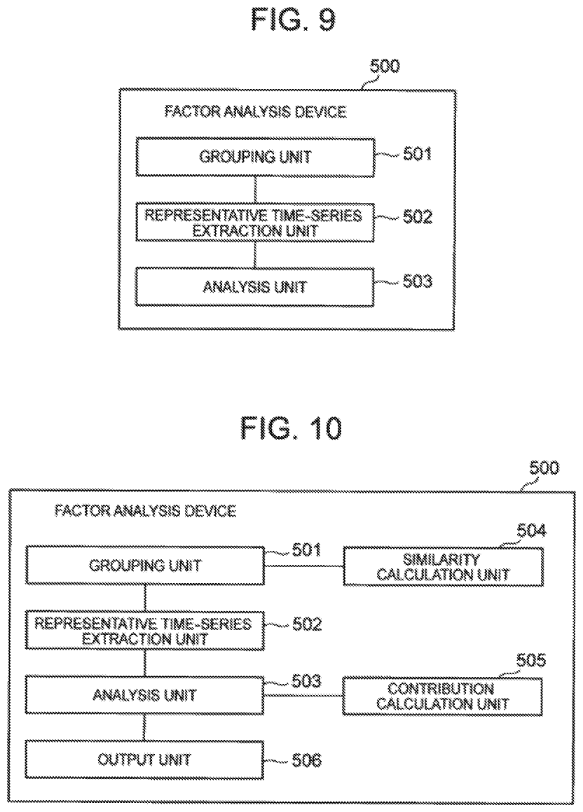

Next, an outline of the present invention will be described. FIG. 9 is a block diagram showing a main part of the present invention. A factor analysis device 500 shown in FIG. 9 includes a grouping unit 501, a representative time-series extraction unit 502, and an analysis unit 503.

When a plurality of time-series of explanation corresponding to one time-series of objective are received, the grouping unit 501 (for example, the grouping unit 103) divides the received time-series of explanation into one or more groups such that similar time-series of explanation belong to a same group.

The representative time-series extraction unit 502 (for example, the analyzed object determination unit 104) extracts a representative time-series of explanation (the time series of analyzed data described above) from each group divided by the grouping unit 501. An extraction method of the representative time-series of explanation is not particularly limited, and it is only required to extract the time-series of explanation of less number than the number of elements in the group, in a case where there are a plurality of time-series of explanation in the group.

The analysis unit 503 (for example, the factor identification unit 106) identifies the time-series of explanation considered to be an influence factor for the time-series of objective, by using the time-series of explanation extracted by the representative time-series extraction unit 502.

According to such a configuration, it is possible to correctly identify an influence factor even when there are multiple types of time-series of explanation considered to be an influence factor for a time-series of objective, and there are a plurality of time-series of explanation acting in the similar manner among the time-series of explanation considered to be an influence factor. That is, the factor analysis device according to the present invention performs grouping such that similar time-series of explanation belong to a same group before performing the analysis, and extracts a representative time-series of explanation as the analyzed object from each group. As a result, even when the plurality of received time-series of explanation include similar time-series of explanation, only the representative time-series of explanation can be made as the analyzed object. That is, according to the factor analysis device of the present invention, analysis can be performed excluding the similar time-series of explanation to the representative time-series of explanation. This makes it possible to correctly identify a factor even when there are multiple types of time-series of explanation considered to be an influence factor for a time-series of objective, and there are a plurality of time-series of explanation having acting in the similar manner among the time-series of explanation considered to be a factor.

Further, in the above configuration, the representative time-series extraction unit 502 may extract a time-series of explanation that contributes most to a value change of the time-series of objective in the group, as a representative time-series of explanation of the group. In addition, the representative time-series extraction unit 502 may extract new time-series of data generated by a mathematical operation on the time-series of explanation in the group, as the representative time-series of explanation of the group.

The new time-series of data may be, for example, time-series of data constituted of the sum of individual values of the time-series of explanation belonging to the same group.

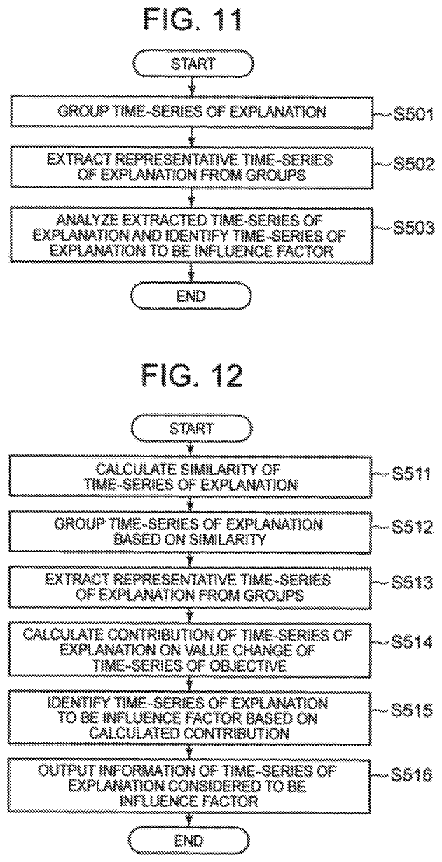

Further, FIG. 10 is a block diagram showing another example of the factor analysis device of the present invention. As shown in FIG. 11, the factor analysis device 500 may further include a similarity calculation unit 504, a contribution calculation unit 505, and an output unit 506.

The similarity calculation unit 504 (for example, the similarity calculation unit 102) calculates the similarity for all pairs of the received time-series of explanation.

In such a case, the grouping unit 501 may group the plurality of time-series of explanation on the basis of the similarity calculated for all the pairs of the received time-series of explanation. For example, considering the time-series of explanation having the similarity equal to or more than a predetermined value to have a similarity relationship with each other, the grouping unit 501 may regard, as one group, a set of the time-series of explanation in which all time-series of explanation in a group have a similarity relationship with all other time-series of explanation in the group.

At this time, for example, the similarity calculation unit 504 may calculate the similarity on the basis of a correlation coefficient calculated between two pieces of time-series of data (time-series of explanation) as the calculation object, or on the basis of a degree of fitness of the relational expression established between the data.

Further, the contribution calculation unit 505 (for example, the contribution calculation unit 105) calculates a contribution to a value change of the time-series of objective for each of the extracted time-series of explanation (representative time-series of explanation). The contribution calculation unit 505 may calculate a contribution to a value change of the time-series of objective of each representative time-series of explanation by using, for example, one or more multivariate analyses.

In addition, when calculating the contribution, the contribution calculation unit 505 may perform, as preprocessing, a process of obtaining new information by a mathematical operation from partial time-series of data included in the time-series of explanation as the calculation object, and processing the time-series of explanation on the basis of the obtained information. This preprocessing may be a process of changing a start time of a time window to extract one or more pieces of information obtained by the mathematical operation from the partial time series included in a time window of a predetermined start time of the time-series of explanation as the calculation object, and adding to the time series of analyzed data.

In such a case, the analysis unit 503 may identify a time-series of explanation considered to be an influence factor for the time-series of objective, on the basis of the calculated contribution.

The output unit 506 (for example, the result display unit 107) outputs information of the time-series of explanation identified by the analysis unit 503. At this time, the output unit 506 may output, in addition to information of the identified time-series of explanation, information of another time-series of explanation in a group to which the time-series of explanation belongs.

Here, in a case where the time-series of explanation identified by the analysis unit 503 is a representative time-series of explanation of a group having a plurality of time-series of explanation, the output unit 506 may collectively output all the time-series of explanation in the group as one type of influence factor.

By the method as described above, even in a case where there are time-series of explanation having a similarity relationship, such as a case where measurement values and correction values different in measurement method are individually collected as explanatory variables for one item of a physical quantity, the problem of multicollinearity can be avoided by using one of them as an analyzed object. Furthermore, according to this method, even in a case where there are multiple types of items of the physical quantity considered to be a factor, by grouping a plurality of pieces time-series of data acting in the similar manner and limiting the analyzed object, even a time-series of explanation corresponding to another type of the item having a relatively low degree of contribution can be correctly identified as an influence factor, without being buried in the time-series of explanation corresponding to a type of the item having a high degree of contribution.

Further, FIG. 11 is a flowchart showing an outline of a factor analysis method of the present invention. Note that each step is performed by, for example, an information processing apparatus operating in accordance with a program.

As shown in FIG. 11, first, when a plurality of time-series of explanation corresponding to one time-series of objective are received, the plurality of received time-series of explanation are divided into one or more groups such that time-series of explanation having a similarity relationship belong to the same group (step S501).

Next, from each group, a representative time-series of explanation is extracted (step S502).

Finally, the extracted time-series of explanation is analyzed, and a time-series of explanation considered to be an influence factor for the time-series of objective is identified (step S503).

Further, FIG. 12 is a flowchart showing another example of the factor analysis method of the present invention. Note that each step is performed by, for example, an information processing apparatus.

As shown in FIG. 12, in this example, first, a similarity is calculated for all pairs of the received time-series of explanation (step S511).

Next, the grouping unit 501 groups the received time-series of explanation on the basis of the calculated similarity (step S512).

Next, from each group, a representative time-series of explanation is extracted (step S513).

Next, for the time-series of explanation extracted in step S513, the contribution to a value change of the time-series of objective is calculated (step S514).

Next, on the basis of the contribution calculated in step S514, a time-series of explanation considered to be an influence factor for the time-series of objective is identified (step S515).

Finally, on the basis of the identification result in step S515, information of the time-series of explanation considered to be an influence factor is outputted. In step S515, for example, in a case where another time-series of explanation is included in a group to which the time-series of explanation considered to be an influence factor belongs, information of the another time-series of explanation may be additionally outputted.

Moreover, in extracting the representative time-series of explanation on the basis of the contribution in step S513, step S514 may be performed before step S513. In that case, in step S514, the contribution to a value change of the time-series of objective is calculated for all the time-series of explanation.

At this time, the contribution to a value change of the time-series of objective may be calculated using two or more multivariate analyses for each time-series of explanation.

According to the method as described above, it is possible to further improve the factor analysis accuracy, and to present in more detail information of an item of a physical quantity considered to be an influence factor.

In addition, each of the above exemplary embodiments can be described as the following supplementary notes.

### (Supplementary Note 1)

A factor analysis method comprising, when a plurality of time-series of explanation, which are time-series of data of a plurality of explanatory variables corresponding to a time-series of objective that is time-series of data of one objective variable, are received, dividing the time-series of explanation into one or more groups such that time-series of explanation having a similarity relationship belong to a same group; extracting a representative time-series of explanation from each group; and analyzing an extracted time-series of explanation to identify a time-series of explanation considered to be an influence factor for the time-series of objective.

### (Supplementary Note 2)

The factor analysis method according to Supplementary note 1, further comprising: outputting, in addition to information of an identified time-series of explanation, information of another time-series of explanation in a group to which the time-series of explanation belong.

### (Supplementary Note 3)

The factor analysis method according to Supplementary note 1 or 2, further comprising: calculating a similarity for all pairs of the received time-series of explanation; and regarding, as one group, a set of the time-series of explanation in which all time-series of explanation in a group have a similarity relationship with all other time-series of explanation in the group, while considering time-series of explanation having a similarity equal to or more than a predetermined value to have a similarity relationship with each other.

### (Supplementary Note 4)

The factor analysis method according to supplementary note 3, wherein a similarity is calculated based on a correlation coefficient calculated between two pieces of time-series of data or based on a degree of fitness of a relational expression established between two pieces of time-series of data.

### (Supplementary Note 5)

The factor analysis method according to any one of Supplementary notes 1 to 4, further comprising: extracting a time-series of explanation affecting most to a value change of a time-series of objective in a group as a representative time-series of explanation of the group.

(Supplementary Note 6) The factor analysis method according to any one of Supplementary notes 1 to 5, further comprising: extracting new time-series of data generated by a mathematical operation on a time-series of explanation in a group as a representative time-series of explanation of the group.
(Supplementary Note 7) The factor analysis method according to any one of Supplementary notes 1 to 6, further comprising: calculating a contribution to a value change of a time-series of objective for each of the extracted time-series of explanation by using two or more multivariate analyses; and identifying a time-series of explanation considered to be an influence factor for the time-series of objective on the basis of the calculated contribution.

### (Supplementary Note 8)

The factor analysis method according to Supplementary note 7, further comprising: performing, as preprocessing in calculating the contribution, a process of obtaining new information by a mathematical operation from partial time-series of data included in the time-series of explanation as the calculation object; and processing the time-series of explanation on the basis of the obtained information.

### (Supplementary Note 9)

The factor analysis method according to any one of Supplementary notes 1 to 8, in which the explanatory variable is to indicate an operating condition of a system, and the objective variable is to indicate a state of the system.

### (Supplementary Note 10)

A factor analysis device comprising: a grouping unit which divides a plurality of time-series of explanation, which are time-series of data of a plurality of explanatory variables corresponding to a time-series of objective that is time-series of data of one objective variable, into one or more groups such that time-series of explanation having a similarity relationship belong to a same group; a representative time-series extraction unit which extracts a representative time-series of explanation from each group; and an analysis unit which analyzes an extracted time-series of explanation to identify a time-series of explanation considered to be an influence factor for the time-series of objective.

### (Supplementary Note 11)

The factor analysis device according to Supplementary note 10, further comprising: an output unit which outputs, in addition to information of the identified time-series of explanation, information of another time-series of explanation in a group to which the time-series of explanation belongs.

### (Supplementary Note 12)

A factor analysis program for causing a computer to execute: a process of dividing a plurality of time-series of explanation, which are time-series of data of a plurality of explanatory variables corresponding to a time-series of objective that is time-series of data of one objective variable, into one or more groups such that time-series of explanation having a similarity relationship belong to a same group; a process of extracting a representative time-series of explanation from each group; and a process of analyzing an extracted time-series of explanation to identify a time-series of explanation considered to be an influence factor for the time-series of objective.

### (Supplementary Note 13)

The factor analysis program according to supplementary note 12, for causing the computer to execute a process of outputting information of another time-series of explanation in a group to which the time-series of explanation belongs, in addition to information of the identified time-series of explanation.

Although the present invention has been described with reference to the exemplary embodiments and examples, the present invention is not limited to the above exemplary embodiments and examples. Various changes that can be understood by those skilled in the art can be made to the configuration and details of the present invention within the scope of the present invention.

### INDUSTRIAL APPLICABILITY

The present invention is widely applicable to application for analyzing factors that determine a value change of an objective variable in devices, systems, and methods capable of obtaining a plurality of explanatory variables and an objective variable described by the plurality of explanatory variables.

### REFERENCE SIGNS LIST

1, 500 Factor analysis device
10 Operation device
101 Data collection unit
102 Similarity calculation unit
103 Grouping unit
104 Analyzed object determination unit
105 Contribution calculation unit
106 Factor identification unit
107 Result display unit
106′ Factor display unit
11 Data storage unit
11′ Storage device
111 Time-series of objective storage unit
112 Time-series of explanation storage unit
113 Similarity storage unit
114 Group storage unit
115 Time-series of analyzed data storage unit
116 Contribution storage unit
117 Time-series of observed data storage unit
12 Display device
2 Device to be analyzed
2′ Sensor
501 Grouping unit
502 Representative time-series extraction unit
503 Analysis unit
504 Similarity calculation unit
505 Contribution calculation unit
506 Output unit
1000 Computer
1001 CPU
1002 Main storage device
1003 Auxiliary storage device
1004 Interface
1005 Display device

What is claimed is:

1. A factor analysis method implemented by a processor, the method comprising:
dividing, when a plurality of time-series of explanation are received, the plurality of time-series of explanation being time-series of data of a plurality of explanatory variables corresponding to a time-series of objective that is time-series of data of one objective variable, the time-series of explanation into one or more groups to allow similar time-series of explanation belong to a group;
extracting a representative time-series of explanation from each group; and
analyzing an extracted time-series of explanation to identify a time-series of explanation considered to be an influence factor for the time-series of objective.

2. The factor analysis method according to claim 1, further comprising:
outputting, in addition to information of an identified time-series of explanation, information of another time-series of explanation in a group to which the time-series of explanation belongs.

3. The factor analysis method according to claim 1, further comprising:
calculating a similarity for all pairs of an received time-series of explanation; and
regarding, as one group, a set of time-series of explanation in which all time-series of explanation in a group have a similarity relationship with all other time-series of explanation in the group, while considering time-series of explanation having a similarity equal to or more than a predetermined value to have a similarity relationship with each other.

4. The factor analysis method according to claim 3, wherein
a similarity is calculated based on a correlation coefficient calculated between two pieces of time-series of data or based on a degree of fitness of a relational expression established between two pieces of time-series of data.

5. The factor analysis method according to claim 1, further comprising:
extracting a time-series of explanation affecting most to a value change of a time-series of objective in a group, as a representative time-series of explanation of the group.

6. The factor analysis method according to claim 1, further comprising:
extracting new time-series of data generated by a mathematical operation on a time-series of explanation in a group, as a representative time-series of explanation of the group.

7. The factor analysis method according to claim 1, further comprising:
calculating a contribution to a value change of a time-series of objective for each extracted time-series of explanation by using two or more multivariate analyses; and
identifying a time-series of explanation considered to be an influence factor, based on the contribution.

8. The factor analysis method according to claim 7, further comprising:
performing, as preprocessing in calculating a contribution, a process of obtaining new information by a mathematical operation from partial time-series of data included in a time-series of explanation of a calculation object, and processing the time-series of explanation based on obtained information.

9. A factor analysis device comprising:
a memory storing a software component; and
at least one processor configured to execute the software component to perform:
dividing a plurality of time-series of explanation that are time-series of data of a plurality of explanatory variables corresponding to a time-series of objective that is time-series of data of one objective variable, into one or more groups to allow time-series of explanation having a similarity relationship to belong to a same group;
extracting a representative time-series of explanation from each group; and
analyzing an extracted time-series of explanation to identify a time-series of explanation considered to be an influence factor for the time-series of objective.

10. A non-transitory computer readable information recording medium storing a factor analysis program, when executed by a processor, performs:
dividing a plurality of time-series of explanation that are time-series of data of a plurality of explanatory variables corresponding to a time-series of objective that is time-series of data of one objective variable, into one or more groups to allow time-series of explanation having a similarity relationship to belong to a same group;
extracting a representative time-series of explanation from each group; and
analyzing an extracted time-series of explanation to identify a time-series of explanation considered to be an influence factor for the time-series of objective.

11. The factor analysis device according to claim 9, wherein
the processor configured to further execute to display, in addition to information of the identified time-series of explanation, information of another time-series of explanation in a group to which the time-series of explanation belongs.

12. The computer readable information recording medium according to claim 10, wherein
the factor analysis program further performs displaying information of another time-series of explanation in a group to which the time-series of explanation belongs, in addition to information of the identified time-series of explanation.
